(19) United States
(12) Patent Application Publication
(10) Pub. No.: US 2025/0131550 A1
(43) Pub. Date: Apr. 24, 2025

(54) IMAGE PROCESSING DEVICE, IMAGE PROCESSING METHOD, AND PROGRAM

(71) Applicant: NIPPON TELEGRAPH AND TELEPHONE CORPORATION, Tokyo (JP)

(72) Inventors: Wataru ITO, Tokyo (JP); Atsushi ARATAKE, Tokyo (JP); Yosuke SAKURADA, Tokyo (JP); Daisuke UCHIBORI, Tokyo (JP); Kazuaki WATANABE, Tokyo (JP)

(73) Assignee: NIPPON TELEGRAPH AND TELEPHONE CORPORATION, Tokyo (JP)

(21) Appl. No.: 18/836,557

(22) PCT Filed: Feb. 8, 2022
(86) PCT No.: PCT/JP2022/004978

§ 371 Date: Aug. 7, 2024

(51) Int. Cl. G06T 7/00; G06T 7/11; G06T 7/174

(52) U.S. Cl. CPC G06T 7/0002; G06T 7/11; G06T 7/174; G06T 2207/20021; G06T 2207/20081; G06T 2207/20132; G06T 2207/20212; G06T 2207/30184

(57) ABSTRACT

An image processing device (10) according to the present disclosure includes: an image division unit (12) that divides an image to be processed including a predetermined object into a plurality of divided images having a predetermined size; a region detection unit (13) that detects, for each of the plurality of divided images, an object region that is a pixel region of the object in each divided image and a deterioration region that is a pixel region of a deterioration portion of the object; an information combining unit (14) that generates an object detection result image obtained by combining images of a plurality of the object regions detected for the respective plurality of divided images while maintaining a positional relationship among the plurality of divided images, and a deterioration detection result image obtained by combining images of a plurality of the deterioration regions detected for the respective plurality of divided images while maintaining the positional relationship among the plurality of divided images; and a diagnosis unit (15) that diagnoses deterioration of the object on the basis of the object detection result image and the deterioration detection result image.

### TECHNICAL FIELD

The present disclosure relates to an image processing device, an image processing method, and a program.

### BACKGROUND ART

In recent inspection of an infrastructure facility, there is used a method of automatically determining presence or absence of deterioration and a degree of deterioration of the facility by using a captured image of the facility and artificial intelligence (AI) created by a deep learning method. At that time, not to overlook even minute deterioration, it is important to use an image with as high resolution as possible as an image to be used for determination. However, in a case where the deep learning method is applied to a high resolution image, there is a problem that, by a graphics processing unit (GPU) in the market, calculation is impossible or it takes a lot of time even if calculation is possible.

To cope with such a problem, it is conceivable to use a high-performance computer. However, as imaging equipment (for example, an inexpensive compact digital camera) used in a field of inspection of an infrastructure facility, equipment having a captured image of about 20 million pixels is the mainstream, and it is difficult to prepare a computer as a distributed product capable of analyzing the captured image of such imaging equipment. For that reason, for example, Non Patent Literatures 1 and 2 describe a technology of compressing an image and performing analysis using a compressed image. By using the compressed image, it is possible to suppress performance required for a computer that performs image analysis and to speed up the image analysis.

### CITATION LIST

### Non Patent Literature

Non Patent Literature 1: Yu Tabata, et al., “UNMANNED INSPECTION ORIENTED UAV BRIDGE INSPECTION AND DAMAGE DETECTION USING DEEP LEARNING”, Journal of Japan Society of Civil Engineers, F4 (Construction Management), Vol. 74, No. 2, p. 62-74, 2018

Non Patent Literature 2: Kengo Kawashiro et al., “Semantic segmentation wo mochiita tunnel no sonsho chushutsu no torikumi (in Japanese) (Approach to tunnel damage extraction using semantic segmentation”, Proceedings of the National Convention of IPSJ, 82nd, No. 4, p. 4.233-4.234, 2020

### SUMMARY OF INVENTION

### Technical Problem

However, in the technology described above, since resolution of the image is reduced due to compression of the image, there is a possibility that detection accuracy is reduced. Furthermore, in the technology described above, there is a possibility that a minute region appearing in a high resolution image before compression disappears due to compression. For that reason, in a case where the technologies described in Non Patent Literatures 1 and 2 are applied to the inspection of the infrastructure facility described above, there is a problem that accuracy of detection of an object (infrastructure facility) and deterioration of the object may decrease.

An object of the present disclosure made in view of the above problem is to provide an image processing device, an image processing method, and a program capable of achieving high accuracy of detection of a predetermined object and deterioration of the object included in an image to be processed and suppressing an increase in processing performance necessary for the detection.

### Solution to Problem

To solve the above problem, an image processing device according to the present disclosure includes: an image division unit that divides an image to be processed including a predetermined object into a plurality of divided images having a predetermined size; a region detection unit that detects, for each of the plurality of divided images, an object region that is a pixel region of the object in each divided image and a deterioration region that is a pixel region of a deterioration portion of the object; an information combining unit that generates an object detection result image obtained by combining images of a plurality of the object regions detected for the respective plurality of divided images while maintaining a positional relationship among the plurality of divided images, and a deterioration detection result image obtained by combining images of a plurality of the deterioration regions detected for the respective plurality of divided images while maintaining the positional relationship among the plurality of divided images; and a diagnosis unit that diagnoses deterioration of the object on the basis of the object detection result image and the deterioration detection result image.

To solve the above problem, an image processing device according to the present disclosure includes: an image division unit that divides an image to be processed including a predetermined object into a plurality of divided images having a predetermined size; an image compression unit that compresses the image to be processed to a predetermined size; an object region detection unit that detects an object region that is a pixel region of the object in the image compressed; a deterioration region detection unit that detects, for each of the plurality of divided images, a deterioration region that is a pixel region of a deterioration portion of the object in each divided image; an information combining unit that generates a deterioration detection result image obtained by combining images of a plurality of the deterioration regions detected for the respective plurality of divided images while maintaining a positional relationship among the plurality of divided images; and a diagnosis unit that diagnoses deterioration of the object on the basis of an object detection result image that is an image of the object region in the image compressed and the deterioration detection result image.

Furthermore, to solve the above problem, an image processing method according to the present disclosure is an image processing method by an image processing device, the image processing method including: a step of dividing an image to be processed including a predetermined object into a plurality of divided images having a predetermined size; a step of detecting, for each of the plurality of divided images, an object region that is a pixel region of the object in each divided image and a deterioration region that is a pixel region of a deterioration portion of the object; a step of generating an object detection result image obtained by combining images of a plurality of the object regions detected for the respective plurality of divided images while maintaining a positional relationship among the plurality of divided images, and a deterioration detection result image obtained by combining images of a plurality of the deterioration regions detected for the respective plurality of divided images while maintaining the positional relationship among the plurality of divided images; and a step of diagnosing deterioration of the object on the basis of the object detection result image and the deterioration detection result image.

Furthermore, to solve the above problem, a program according to the present disclosure causes a computer to operate as the image processing device described above.

### Advantageous Effects of Invention

According to the image processing device, the image processing method, and the program according to the present disclosure, it is possible to achieve high accuracy of detection of a predetermined object and deterioration of the object included in an image to be processed, and it is possible to suppress an increase in processing performance necessary for the detection.

### BRIEF DESCRIPTION OF DRAWINGS

FIG. 1 is a diagram illustrating a configuration example of an image processing device according to a first embodiment of the present disclosure.

FIG. 2 is a diagram illustrating a configuration example of an image division unit illustrated in FIG. 1.

FIG. 3 is a diagram illustrating a configuration example of a region detection unit illustrated in FIG. 1.

FIG. 4 is a flowchart illustrating an example of operation of a number-of-divisions determination unit illustrated in FIG. 2.

FIG. 5 is a diagram for explaining determination of the number of divisions by the number-of-divisions determination unit illustrated in FIG. 2.

FIG. 6 is a flowchart illustrating an example of operation of a division execution unit illustrated in FIG. 2.

FIG. 7 is a diagram illustrating an example of division of an image to be processed by the number-of-divisions determination unit illustrated in FIG. 2.

FIG. 8 is a diagram illustrating another example of the division of the image to be processed by the number-of-divisions determination unit illustrated in FIG. 2.

FIG. 9 is a diagram illustrating still another example of the division of the image to be processed by the number-of-divisions determination unit illustrated in FIG. 2.

FIG. 10 is a flowchart illustrating an example of operation of the image processing device illustrated in FIG. 1.

FIG. 11 is a diagram illustrating a configuration example of an image processing device according to a second embodiment of the present disclosure.

FIG. 12 is a diagram illustrating a configuration example of an object region detection unit illustrated in FIG. 11.

FIG. 13 is a diagram illustrating a configuration example of a deterioration region detection unit illustrated in FIG. 11.

FIG. 14 is a flowchart illustrating an example of operation of the image processing device illustrated in FIG. 11.

FIG. 15 is a diagram illustrating a configuration example of an image processing device according to a third embodiment of the present disclosure.

FIG. 16 is a diagram illustrating another configuration example of the image processing device according to the third embodiment of the present disclosure.

FIG. 17 is a diagram illustrating an example of a hardware configuration of the image processing devices according to the present disclosure.

### DESCRIPTION OF EMBODIMENTS

Hereinafter, an embodiment of the present disclosure will be described with reference to the drawings.

### First Embodiment

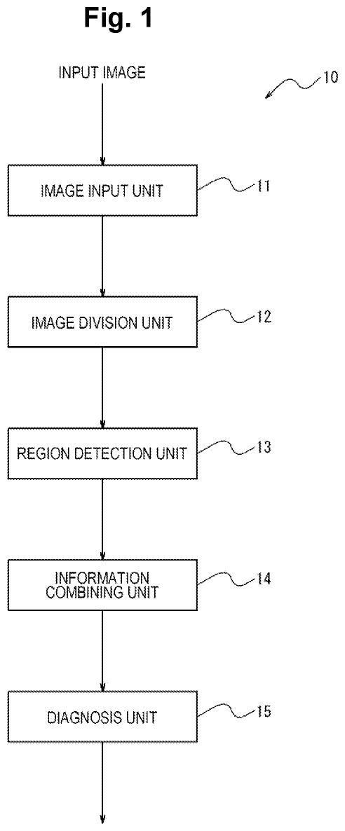

FIG. 1 is a diagram illustrating a configuration example of an image processing device 10 according to a first embodiment of the present disclosure. The image processing device 10 according to the present embodiment detects a predetermined object included in an image to be processed and deterioration of the object. The image to be processed is, for example, an image obtained by capturing an image of an infrastructure facility (for example, a utility pole or the like). In this case, the image processing device 10 detects the infrastructure facility and deterioration of the infrastructure facility from the image to be processed.

As illustrated in FIG. 1, the image processing device 10 according to the present embodiment includes an image input unit 11, an image division unit 12, a region detection unit 13, an information combining unit 14, and a diagnosis unit 15.

An image to be processed is input to the image input unit 11. As described above, the image input to the image input unit 11 is, for example, an image obtained by capturing an image of a predetermined infrastructure facility. The image input unit 11 outputs the input image to the image division unit 12.

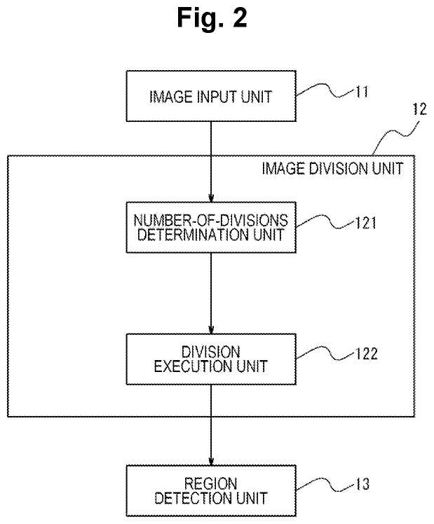

The image division unit 12 divides the image to be processed output from the image input unit 11 into a plurality of divided images having a predetermined size. FIG. 2 is a diagram illustrating a configuration example of the image division unit 12. As illustrated in FIG. 2, the image division unit 12 includes a number-of-divisions determination unit 121 and a division execution unit 122.

The number-of-divisions determination unit 121 determines the number of divisions in the width direction of the image to be processed and the number of divisions in the height direction of the image to be processed. Details of determination of the number of divisions by the number-of-divisions determination unit 121 will be described later.

The division execution unit 122 divides the image to be processed by the number of divisions determined by the number-of-divisions determination unit 121, and outputs the divided images that are images after division to the region detection unit 123. When the image to be processed is sequentially divided, depending on the size and the number of divisions of the divided image, the divided image may protrude from the image to be processed near an end of a processing target. In this case, the division execution unit 122 standardizes the sizes of the divided images (unifies the sizes of the divided images) by, for example, adding predetermined images. Details of division of the image to be processed by the division execution unit 122 will be described later.

Referring again to FIG. 1, the image division unit 12 outputs the plurality of divided images obtained by dividing the image to be processed to the region detection unit 13.

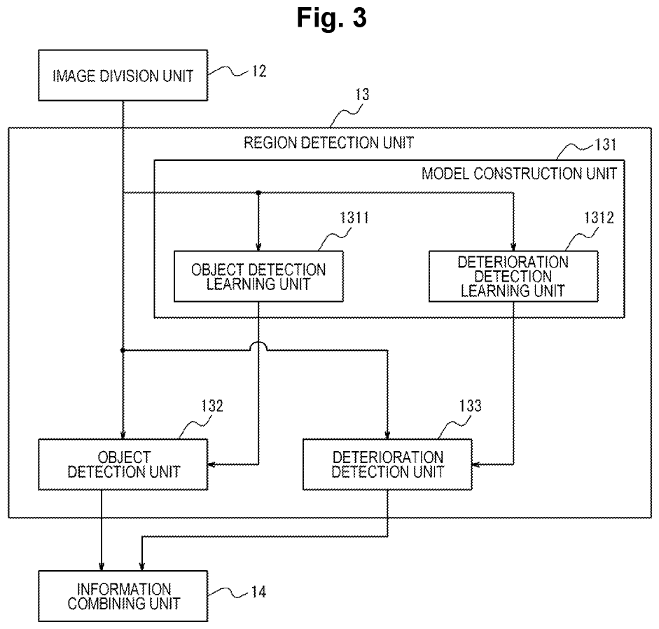

For each of the plurality of divided images output from the image division unit 12, the region detection unit 13 detects an object region that is a pixel region of an object in each divided image and a deterioration region that is a pixel region of a deterioration portion of the object. FIG. 3 is a diagram illustrating a configuration example of the region detection unit 13. In FIG. 3, a description will be given using an example in which the region detection unit 13 has a function of creating a model for detecting the object region and the deterioration region from the divided image, and a function of detecting the object region and the deterioration region from the divided image by using the created model.

As illustrated in FIG. 3, the region detection unit 13 includes a model construction unit 131, an object detection unit 132, and a deterioration detection unit 133. As described above, the region detection unit 13 has the function of creating the model for detecting the object region and the deterioration region from the divided image, and the function of detecting the object region and the deterioration region from the divided image by using the created model. The divided images to be used for creating the model are input to the model construction unit 131. Furthermore, the divided images on which detection is to be performed of the object and the deterioration are input to the object detection unit 132 and the deterioration detection unit 133.

Using the input divided images, the model construction unit 131 creates a model (detector) for detecting the object region in an image and a model for detecting the deterioration region by a deep learning method. As illustrated in FIG. 3, the model construction unit 131 includes an object detection learning unit 1311 and a deterioration detection learning unit 1312.

The object detection learning unit 1311 uses a divided image and a mask image indicating the object region in the divided image to create an object detector that is a detector for detecting the object region in an image, by the deep learning method. The object detection learning unit 1311 stores the created object detector in the object detection unit 132.

The deterioration detection learning unit 1312 uses a divided image and a mask image indicating the deterioration region in the divided image to create a deterioration detector that is a detector for detecting the deterioration region in an image, by the deep learning method. The deterioration detection learning unit 1312 stores the created deterioration detector in the deterioration detection unit 133.

The object detection unit 132 detects the object region in an input divided image (divided image that is a target of detection of the object region) by using the object detector created by the object detection learning unit 1311. The object detection unit 132 outputs a result of detection of the object region to the information combining unit 14.

The deterioration detection unit 133 detects the deterioration region in an input divided image (divided image that is a target of detection of the deterioration region) by using the deterioration detector created by the deterioration detection learning unit 1312. The deterioration detection unit 133 outputs a result of detection of the deterioration region to the information combining unit 14.

Note that, in FIG. 3, an example has been described in which the region detection unit 13 has a function of creating the object detector and the deterioration detector, but the present invention is not limited thereto. The object detector and the deterioration detector may be created outside the image processing device 10 and stored in the object detection unit 132 and the deterioration detection unit 133. In this case, the region detection unit 13 does not have to include the model construction unit 131.

Referring again to FIG. 1, the information combining unit 14 generates an object detection result image obtained by combining images of the object regions detected for the respective plurality of divided images by the region detection unit 13 (object detection unit 132). As described above, the object region is detected for each of the plurality of divided images obtained by dividing the image to be processed. For that reason, the information combining unit 14 combines the images of the object regions detected for the respective plurality of divided images to generate the object detection result image while maintaining a positional relationship among the plurality of divided images.

Furthermore, the information combining unit 14 generates a deterioration detection result image obtained by combining images of the deterioration regions detected for the respective plurality of divided images by the region detection unit 13 (deterioration detection unit 133). As described above, the deterioration region is detected for each of the plurality of divided images obtained by dividing the image to be processed. For that reason, the information combining unit 14 combines the images of the deterioration regions detected for the respective plurality of divided images to generate a deterioration detection result image while maintaining the positional relationship among the plurality of divided images.

The information combining unit 14 outputs the generated object detection result image and deterioration detection result image to the diagnosis unit 15.

The diagnosis unit 15 diagnoses deterioration of the object on the basis of the object detection result image and the deterioration detection result image output from the information combining unit 14. For example, the diagnosis unit 15 superimposes the object detection result image and the deterioration detection result image on each other, and calculates a deterioration rate of the object from a ratio of the deterioration region to the object region.

The image processing device 10 according to the present embodiment divides an image to be processed into a plurality of divided images, and detects an object region and a deterioration region for each of the plurality of divided images. For that reason, since it is not necessary to compress the image (the number of pixels of a region of a detection target is not reduced), it is possible to achieve high accuracy of detection of the object and the deterioration of the object included in the image to be processed. Furthermore, by detecting the object region and the deterioration region of the divided image obtained by dividing the image to be processed, it is possible to suppress an increase in processing performance necessary for the detection.

Next, a description will be given of operation of the image processing device 10 according to the present embodiment.

First, a description will be given of determination of the number of divisions of the image to be processed by the number-of-divisions determination unit 121.

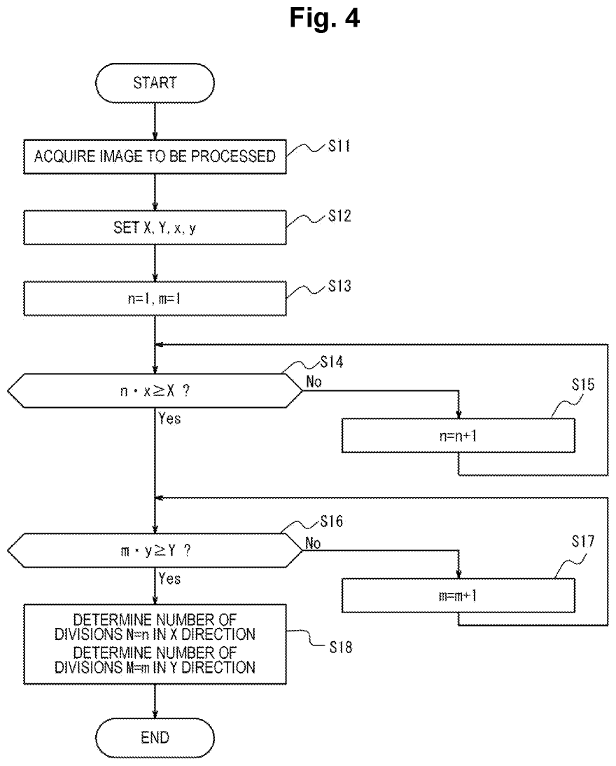

FIG. 4 is a flowchart illustrating an example of operation of the number-of-divisions determination unit 121.

The number-of-divisions determination unit 121 acquires an image to be processed input via the image input unit 11 (step S11).

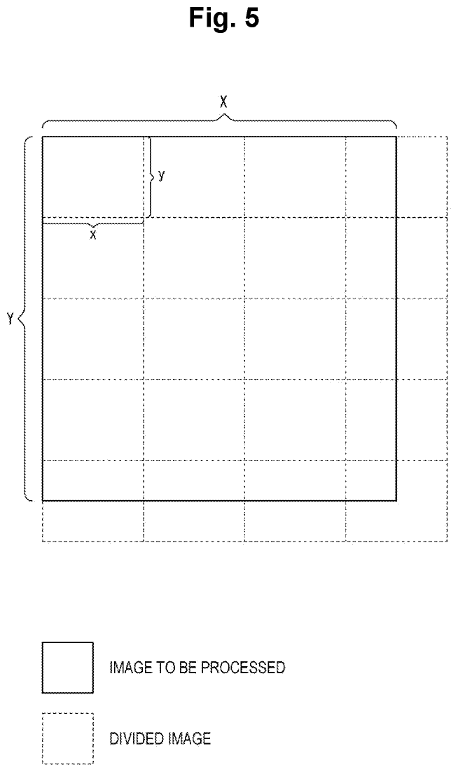

As illustrated in FIG. 5, the number-of-divisions determination unit 121 sets a size in the width direction (X direction) of the acquired image to be processed as X, and sets a size in the height direction (Y direction) of the image to be processed as Y. Furthermore, the number-of-divisions determination unit 121 sets a size in the width direction (X direction) of the divided image as x, and sets a size in the height direction (Y direction) of the image to be processed as y (step S12). Furthermore, the number-of-divisions determination unit 121 sets a variable n=1 and sets a variable m=1 (step S13).

The number-of-divisions determination unit 121 determines whether or not a product of the size x in the width direction of the divided image and the variable n is greater than or equal to the size X in the width direction of the image to be processed (n·x≥X is satisfied) (step S14).

In a case where it is determined that n·x≥X is not satisfied (n·x<X is satisfied) (step S14: No), the number-of-divisions determination unit 121 adds 1 to the variable n (step S15), and returns to the processing of step S14. That is, the number-of-divisions determination unit 121 repeats the processing of steps S14 and S15 until the product of the size x in the width direction of the divided image and the variable n becomes greater than or equal to the size X in the width direction of the image to be processed.

In a case where it is determined that n·x≥X is satisfied (step S14: Yes), the number-of-divisions determination unit 121 determines whether or not a product of the size y in the height direction of the divided image and the variable m is greater than or equal to the size Y in the height direction of the image to be processed (m·y≥Y is satisfied) (step S16).

In a case where it is determined that m·y≥Y is not satisfied (m·y<Y is satisfied) (step S16: No), the number-of-divisions determination unit 121 adds 1 to the variable m (step S17), and returns to the processing of step S16. That is, the number-of-divisions determination unit 121 repeats the processing of steps S16 and S17 until the product of the size y in the height direction of the divided image and the variable m becomes greater than or equal to the size Y in the width direction of the image to be processed.

In a case where it is determined that m·y≥Y is satisfied (step S16: Yes), the number-of-divisions determination unit 121 determines the number of divisions N=n in the width direction (X direction) of the image to be processed and determines the number of divisions M=m in the height direction (Y direction) of the image to be processed (step S18). As described above, the number-of-divisions determination unit 121 (image division unit 12) determines the number of divisions N in the width direction of the image to be processed so that a product of the size x in the width direction of the divided image and the number of divisions N in the width direction of the image to be processed is greater than or equal to the size X in the width direction of the image to be processed. Furthermore, the number-of-divisions determination unit 121 determines the number of divisions M in the height direction of the image to be processed so that a product of the size y in the height direction of the divided image and the number of divisions M in the height direction of the image to be processed is greater than or equal to the size Y in the height direction of the image to be processed.

Next, a description will be given of division of the image to be processed by the division execution unit 122.

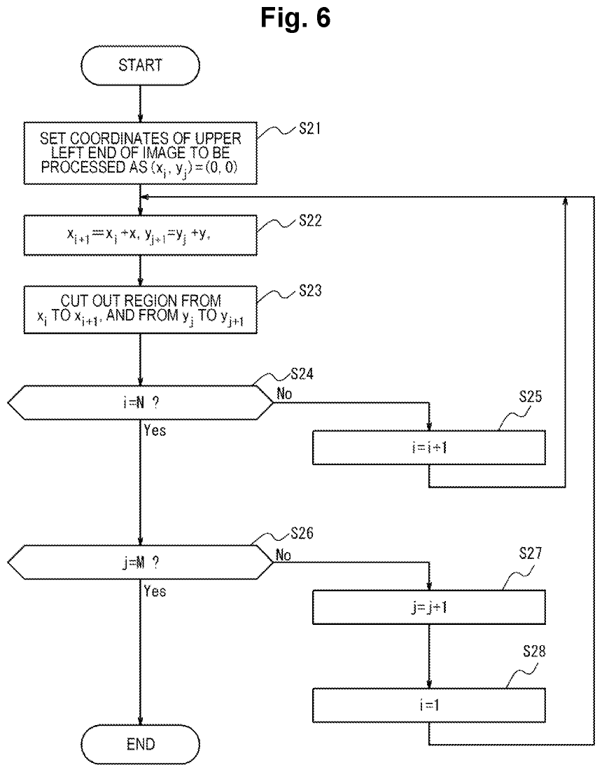

FIG. 6 is a flowchart illustrating an example of operation of the division execution unit 122.

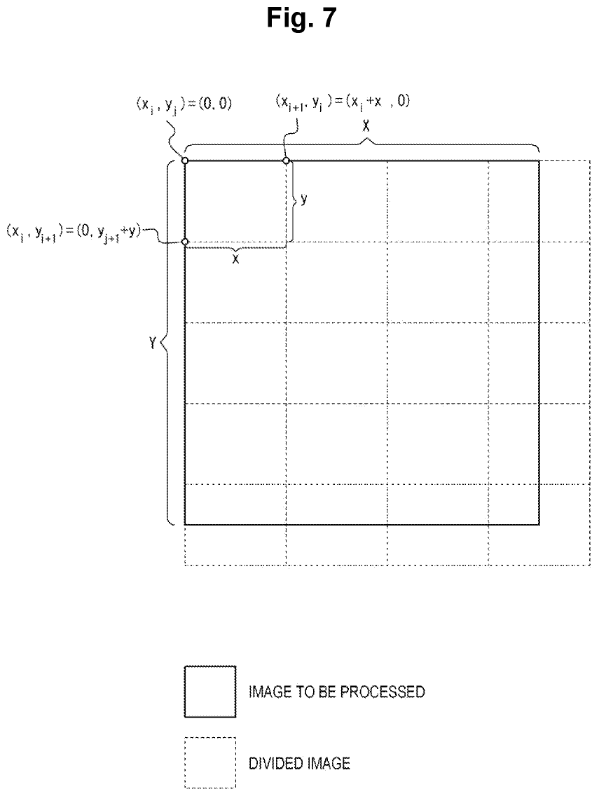

The division execution unit 122 divides the image to be processed, for example, starting from the upper left end of the image to be processed. In this case, as illustrated in FIG. 7, the division execution unit 122 sets coordinates of the upper left end of the image to be processed as (xᵢ, yⱼ)=(0, 0) (step S21).

The division execution unit 122 sets xᵢ₊₁=xᵢ+x, and sets yⱼ₊₁=yⱼ+y (step S22). As described above, x is the size in the width direction of the divided image, and y is the size in the height direction of the divided image.

The division execution unit 122 cuts out a region from xᵢ to xᵢ₊₁ in the width direction and from yⱼ to yⱼ₊₁ in the height direction as a divided image in the image to be processed (step S23).

Next, the division execution unit 122 determines whether or not i=N is satisfied (step S24).

In a case where it is determined that i=N is not satisfied (step S24: No), the division execution unit 122 adds 1 to i (step S25), and returns to the processing of step S22. This processing is repeated until i=N is satisfied, whereby division of the image to be processed in the width direction is repeated N times.

In a case where it is determined that i=N is satisfied (step S24: Yes), the division execution unit 122 determines whether or not j=M is satisfied (step S26).

In a case where it is determined that j=M is not satisfied (step S26: No), the division execution unit 122 adds 1 to j (step S27), sets i=1, and returns to the processing of step S22. This processing is repeated until j=M is satisfied, whereby division of the image to be processed in the height direction is repeated M times.

In a case where it is determined that j=M is satisfied (step S26: Yes), the division execution unit 122 has divided the image to be processed into N×M divided images, and thus ends the processing. According to the processing described with reference to FIG. 6, since the entire image to be processed can be covered with the minimum number of divided images for the image to be processed, it is possible to increase speed of calculation processing in the region detection unit 13.

Note that, as illustrated in FIG. 7, in a case where N·x>X and M·y>Y are satisfied, the divided image may exceed the image to be processed at the right end and the lower end of the processing target. In this case, the division execution unit 122 adds, for example, an image including uniform pixels (for example, a black image including black pixels) to a region exceeding the image to be processed in the divided image. By doing this, the division execution unit 122 can generate divided images having unified sizes.

However, in the method described above, for example, the black image concentrates on the divided images near the right end and the lower end of the processing target. When a ratio of the black image to the divided image is large, a learning effect is reduced even if learning of the model is performed by using the divided image.

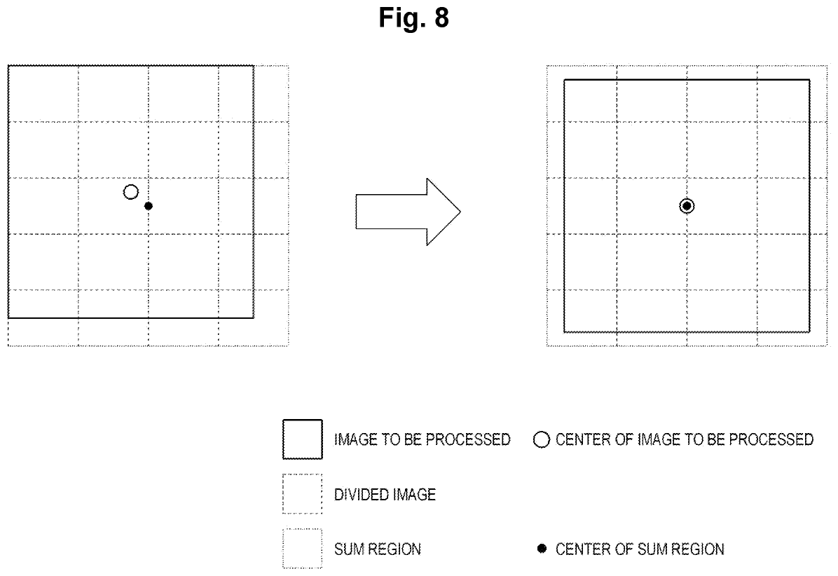

Thus, as illustrated in FIG. 8, the division execution unit 122 may divide the image to be processed into a plurality of divided images such that the center of a region formed by arranging the divided images by the number of divisions determined in each of the height direction and the width direction (Hereinafter, it is referred to as a “sum region of the divided images”.) coincides with the center of the image to be processed.

In the example illustrated in FIG. 5, the black image is concentrated on the divided images near the right end and the lower end of the image to be processed. On the other hand, division is performed such that the center of the image to be processed and an image at the center of the sum region of the divided images coincide with each other, whereby the divided images at the upper, lower, left, and right ends of the image to be processed protrude from the image to be processed as illustrated in FIG. 8, and thus the black image can be dispersed in these divided images.

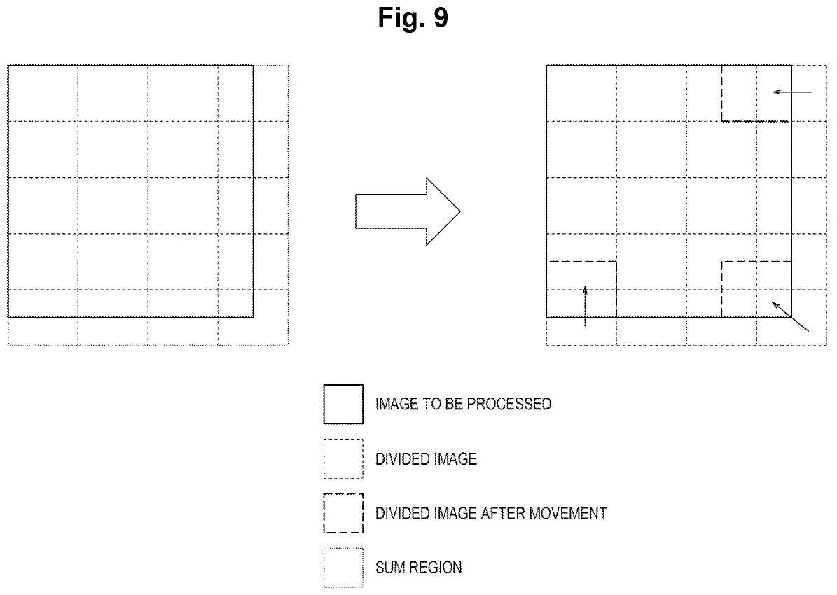

Furthermore, the division execution unit 122 may divide the image to be processed such that the divided image does not protrude from the image to be processed. Specifically, for example, as illustrated in FIG. 9, it is assumed that the sum region of the divided images is greater than the image to be processed, and the divided images protrude from the right end and the lower end of the image to be processed. In this case, the division execution unit 122 moves a divided image protruding from the right end of the processed image in the left direction to cause the divided image to overlap a divided image adjacent in the left direction, thereby preventing the divided image from protruding from the image to be processed. Furthermore, the division execution unit 122 moves a divided image protruding from the lower end of the processed image in the upward direction and causes the divided image to overlap a divided image adjacent in the upward direction, thereby preventing the divided image from protruding from the image to be processed. Furthermore, the division execution unit 122 moves a divided image protruding from the right end and the lower end of the processed image in the left direction and the upward direction and causes the divided image to overlap divided images adjacent in the left direction and the upward direction, thereby preventing the divided image from protruding from the image to be processed.

As described above, in a case where the sum region of the divided images is greater than the image to be processed, the division execution unit 122 (image division unit 12) may superimpose the adjacent divided images on each other so that the size of the sum region of the divided images matches the size of the image to be processed. By doing this, since the black image is not added to the divided image protruding from the image to be processed, it is possible to prevent a decrease in the learning effect using the divided image.

Next, a description will be given of operation of the image processing device 10 according to the present embodiment.

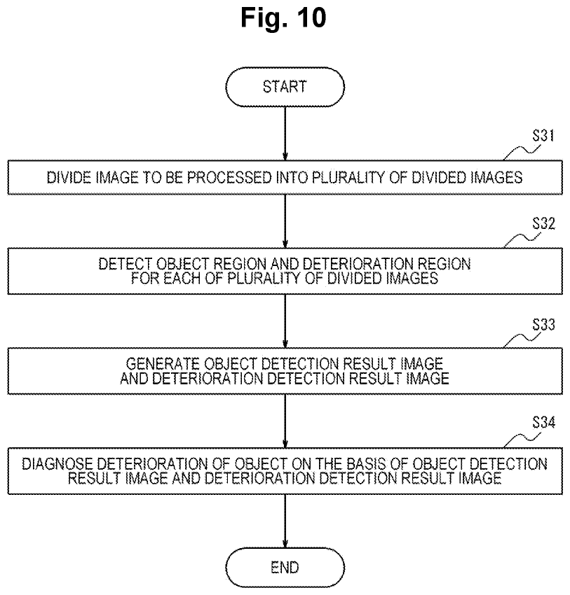

FIG. 10 is a flowchart illustrating an example of the operation of the image processing device 10 according to the present embodiment, and is a diagram for explaining an image processing method by the image processing device 10 according to the present embodiment.

The image division unit 12 divides an image to be processed including a predetermined object input via the image input unit 11 into a plurality of divided images having a predetermined size (step S31).

For each of the plurality of divided images, the region detection unit 13 detects an object region that is a pixel region of the object in each divided image and a deterioration region that is a pixel region of a deterioration portion of the object (step S32).

The information combining unit 14 generates an object detection result image obtained by combining images of the object regions detected for the respective plurality of divided images while maintaining a positional relationship among the plurality of divided images. Furthermore, the information combining unit 14 generates a deterioration detection result image obtained by combining images of the deterioration regions detected for the respective plurality of divided images while maintaining the positional relationship among the plurality of divided images (step S33).

The diagnosis unit 15 diagnoses deterioration of the object on the basis of the generated object detection result image and deterioration detection result image. For example, the diagnosis unit 15 superimposes the object detection result image and the deterioration detection result image on each other, and calculates a deterioration rate of the object from a ratio of the deterioration region to the object region.

As described above, the image processing device 10 according to the present embodiment includes the image division unit 12, the region detection unit 13, the information combining unit 14, and the diagnosis unit 15. The image division unit 12 divides an image to be processed including a predetermined object into a plurality of divided images having a predetermined size. The region detection unit 13 detects, for each of the plurality of divided images, an object region that is a pixel region of the object in the divided image and a deterioration region that is a pixel region of a deterioration portion of the object. The information combining unit 14 generates an object detection result image obtained by combining images of the object regions detected for the respective plurality of divided images while maintaining a positional relationship among the plurality of divided images, and a deterioration detection result image obtained by combining images of the deterioration regions detected for the respective plurality of divided images while maintaining the positional relationship among the plurality of divided images. The diagnosis unit 15 diagnoses deterioration of the object on the basis of the object detection result image and the deterioration detection result image.

Furthermore, the image processing method by the image processing device 10 according to the present embodiment includes: a step of dividing, by the image division unit 12, an image to be processed including a predetermined object into a plurality of divided images having a predetermined size (step S31); a step of detecting, by the region detection unit 13, for each of the plurality of divided images, an object region that is a pixel region of the object in each divided image and a deterioration region that is a pixel region of a deterioration portion of the object (step S32); a step of generating, by the information combining unit 14, an object detection result image obtained by combining images of the object regions detected for the respective plurality of divided images while maintaining a positional relationship among the plurality of divided images, and a deterioration detection result image obtained by combining images of the deterioration regions detected for the respective plurality of divided images while maintaining the positional relationship among the plurality of divided images (step S33); and a step of diagnosing, by the diagnosis unit 15, deterioration of the object on the basis of the object detection result image and the deterioration detection result image (step S34).

Since the detection can be performed without reducing the number of pixels of the region of the detection target by detecting the object region and the deterioration region for the divided image obtained by dividing the image to be processed, it is possible to achieve high accuracy of detection of a predetermined object and deterioration of the object. Furthermore, by detecting the object region and the deterioration region of the divided image obtained by dividing the image to be processed, it is possible to suppress an increase in processing performance necessary for the detection.

### Second Embodiment

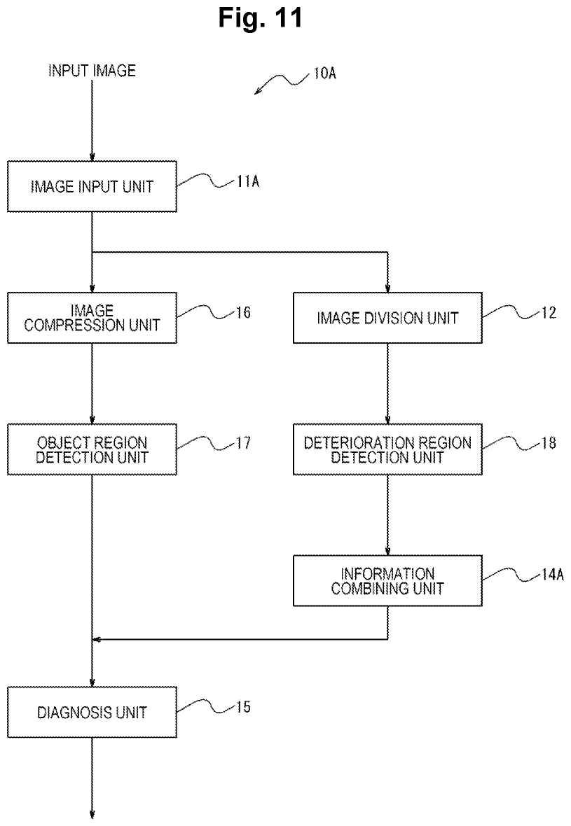

FIG. 11 is a diagram illustrating a configuration example of an image processing device 10A according to a second embodiment of the present invention. In the image processing device 10 according to the first embodiment, divided images are used for detection of each of an object and deterioration of the object. In this case, the number of images used for learning and detection increases and a calculation time increases as compared with a case where an image resized (reduced in size) by compression is used for learning and detection. Furthermore, since the infrastructure facility generally has a uniform shape, detection of the infrastructure facility in an image greatly depends on shape characteristics. For that reason, when the image to be processed is divided into a plurality of divided images, the shape characteristics of the infrastructure facility that is the object to be detected are lost, and a detection rate may decrease. Thus, in the image processing device 10A according to the present embodiment, an image obtained by compressing an image to be processed is used for detection of an object. Hereinafter, a detailed description will be given of a configuration of the image processing device 10A. Note that, in FIG. 11, components similar to those of FIG. 1 are denoted by the same reference signs, and description thereof will be omitted.

As illustrated in FIG. 11, the image processing device 10A according to the present embodiment includes an image input unit 11A, the image division unit 12, an image compression unit 16, an object region detection unit 17, a deterioration region detection unit 18, an information combining unit 14A, and the diagnosis unit 15.

An image to be processed is input to the image input unit 11A. As described above, the image input to the image input unit 11A is, for example, an image obtained by capturing an image of a predetermined infrastructure facility. The image input unit 11A outputs the input image to the image division unit 12 and the image compression unit 16.

The image compression unit 16 compresses the image to be processed output from the image input unit 11A to a predetermined size (standardized size). When compressing the image to be processed, the image compression unit 16 may add predetermined images (for example, black images) to the image to be processed and compress an image formed into an image having the same aspect ratio as that of the standardized size. By doing this, it is possible to prevent a decrease in detection accuracy by the model created by the deep learning due to a change in the aspect ratio due to the compression. The image compression unit 16 outputs a compressed image to the object region detection unit 17.

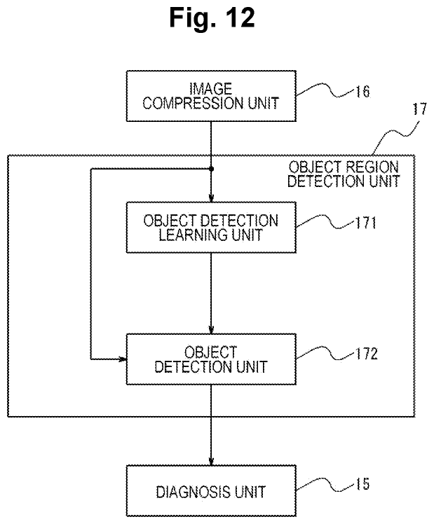

The object region detection unit 17 detects an object region that is a pixel region of the object in the image (compressed image) compressed by the image compression unit 16. FIG. 12 is a diagram illustrating a configuration example of the object region detection unit 17. In FIG. 12, a description will be given using an example in which the object region detection unit 17 has a function of creating a model for detecting the object region from the compressed image and a function of detecting the object region from the compressed image by using the created model.

As illustrated in FIG. 12, the object region detection unit 17 includes an object detection learning unit 171 and an object detection unit 172. As described above, the object region detection unit 17 has the function of creating the model for detecting the object region from the compressed image, and the function of detecting the object region from the compressed image by using the created model. The compressed image to be used for creating the model is input to the object detection learning unit 171. Furthermore, the compressed image on which detection of the object is to be performed is input to the object detection unit 172.

The object detection learning unit 171 uses the compressed image and a mask image indicating the object region in the compressed image to create an object detector that is a detector for detecting the object region in an image, by the deep learning method. The object detection learning unit 171 stores the created object detector in the object detection unit 172.

Note that, in FIG. 12, an example has been described in which the object region detection unit 17 has a function of creating the object detector, but the present invention is not limited thereto. The object detector may be created outside the image processing device 10A and stored in the object detection unit 172. In this case, the object region detection unit 17 does not have to include the object detection learning unit 171.

The object detection unit 172 detects the object region in an input compressed image (compressed image that is a target of detection of the object region) by using the object detector created by the object detection learning unit 171. The object detection unit 172 outputs an object detection result image that is an image of the object region in the compressed image to the diagnosis unit 15 as a result of detection of the object region.

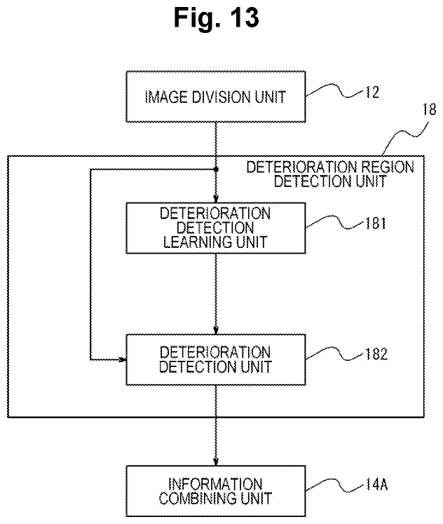

Referring again to FIG. 11, a plurality of divided images obtained by dividing the image to be processed by the image division unit 12 is input to the deterioration region detection unit 18. The deterioration region detection unit 18 detects, for each of the plurality of divided images, a deterioration region that is a pixel region of a deterioration portion of the object in each divided image. FIG. 13 is a diagram illustrating a configuration example of the deterioration region detection unit 18. In FIG. 13, a description will be given using an example in which the deterioration region detection unit 18 has a function of creating a model for detecting the deterioration region from the divided image and a function of detecting the deterioration region from the divided image by using the created model.

As illustrated in FIG. 13, the deterioration region detection unit 18 includes a deterioration detection learning unit 181 and a deterioration detection unit 182. As described above, the deterioration region detection unit 18 has the function of creating the model for detecting the deterioration region from the divided image, and the function of detecting the deterioration region from the divided image by using the created model. The divided images to be used for creating the model are input to the deterioration detection learning unit 181. Furthermore, the divided image on which detection of the deterioration region is to be performed is input to the deterioration detection unit 182.

The deterioration detection learning unit 181 uses the divided image and a mask image indicating the deterioration region in the divided image to create a deterioration detector that is a detector for detecting the deterioration region in an image, by the deep learning method. The deterioration detection learning unit 181 stores the created deterioration detector in the deterioration detection unit 182.

The deterioration detection unit 182 detects the deterioration region in an input divided image (divided image that is a target of detection of the deterioration region) by using the deterioration detector created by the deterioration detection learning unit 181. The deterioration detection unit 182 outputs a result of detection of the deterioration region to the information combining unit 14A.

In FIG. 13, an example has been described in which the deterioration region detection unit 18 has a function of creating the deterioration detector, but the invention is not limited thereto. The deterioration detector may be created outside the image processing device 10A and stored in the deterioration detection unit 182. In this case, the deterioration region detection unit 18 does not have to include the deterioration detection learning unit 181.

Referring again to FIG. 11, the information combining unit 14A generates a deterioration detection result image obtained by combining images of the deterioration regions detected for the respective plurality of divided images while maintaining a positional relationship among the plurality of divided images. The information combining unit 14A outputs the generated deterioration detection result image to the diagnosis unit 15.

The diagnosis unit 15 detects deterioration of the object on the basis of the object detection result image output from the object region detection unit 17 and the deterioration detection result image output from the information combining unit 14A.

The image processing device 10A according to the present embodiment compresses an image to be processed and detects an object region from the compressed image. For that reason, since it is possible to detect the object region while maintaining shape characteristics of the object in the image, detection accuracy of the object region can be improved. Furthermore, similarly to the image processing device 10 according to the first embodiment, a divided image obtained by dividing an image to be processed is used for detection of the deterioration region. For that reason, since it is possible to detect the deterioration region without reducing the number of pixels of the deterioration region, it is possible to achieve high accuracy of detection of the deterioration region. Furthermore, by detecting the object region and the deterioration region by using the compressed image obtained by compressing the processing target and the divided image obtained by dividing the image to be processed, it is possible to suppress an increase in processing performance necessary for the detection.

Next, a description will be given of operation of the image processing device 10A according to the present embodiment.

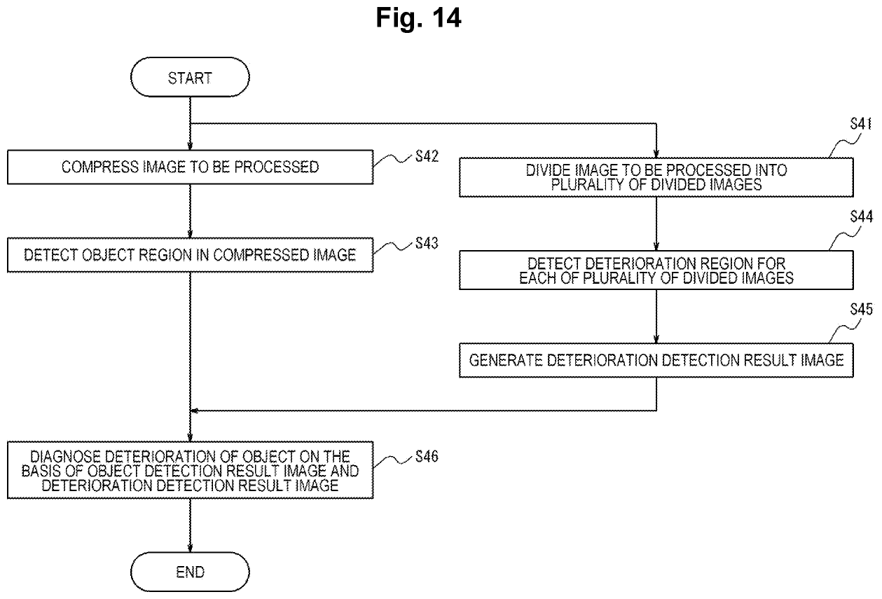

FIG. 14 is a flowchart illustrating an example of the operation of the image processing device 10A according to the present embodiment, and is a diagram for explaining an image processing method by the image processing device 10A according to the present embodiment.

The image division unit 12 divides an image to be processed including a predetermined object into a plurality of divided images having a predetermined size (step S41).

The image compression unit 16 compresses the image to be processed to a predetermined size (step S42). The object region detection unit 17 detects an object region that is a pixel region of the object in an image compressed by the image compression unit 16 (step S43).

The deterioration region detection unit 18 detects, for each of the plurality of divided images, a deterioration region that is a pixel region of a deterioration portion of the object (step S44).

The information combining unit 14A generates a deterioration detection result image obtained by combining images of the deterioration regions detected for the respective plurality of divided images while maintaining a positional relationship among the plurality of divided images (step S45).

The diagnosis unit 15 diagnoses deterioration of the object on the basis of the object detection result image that is an image of the object region in the compressed image and the deterioration detection result image (step S46).

As described above, in the present embodiment, the image processing device 10A includes the image division unit 12, the image compression unit 16, the object region detection unit 17, the deterioration region detection unit 18, the information combining unit 14A, and the diagnosis unit 15. The image division unit 12 divides an image to be processed including a predetermined object into a plurality of divided images having a predetermined size. The image compression unit 16 compresses the image to be processed to a predetermined size. The object region detection unit 17 detects an object region that is a pixel region of the object in the compressed image. The deterioration region detection unit 18 detects, for each of the plurality of divided images, a deterioration region that is a pixel region of a deterioration portion of the object in each divided image. The information combining unit 14A generates a deterioration detection result image obtained by combining images of the deterioration regions detected for the respective plurality of divided images while maintaining a positional relationship among the plurality of divided images. The diagnosis unit 15 diagnoses deterioration of the object on the basis of the object detection result image that is an image of the object region in the compressed image and the deterioration detection result image.

Furthermore, the image processing method by the image processing device 10A according to the present embodiment includes: a step of dividing, by the image division unit 12, an image to be processed including a predetermined object into a plurality of divided images having a predetermined size (step S41); a step of compressing, by the image compression unit 16, the image to be processed into a predetermined size (step S42); a step of detecting, by the object region detection unit 17, an object region that is a pixel region of the object in the compressed image (step S43); a step of detecting, by the deterioration region detection unit 18, for each of the plurality of divided images, a deterioration region that is a pixel region of a deterioration portion of the object in each divided image (step S44); a step of generating, by the information combining unit 14A, a deterioration detection result image obtained by combining images of the deterioration regions detected for the respective plurality of divided images while maintaining a positional relationship among the plurality of divided images (step S45), and a step of diagnosing, by the diagnosis unit 15, deterioration of the object on the basis of the object detection result image that is an image of the object region in the compressed image and the deterioration detection result image (step S46).

Since it is possible to detect the object region while maintaining the shape characteristics of the object in the image by compressing the image to be processed and detecting the object region from the compressed image, the detection accuracy of the object region can be improved. Furthermore, since it is possible to detect the deterioration region without reducing the number of pixels of the deterioration region by using the divided image obtained by dividing the image to be processed for the detection of the deterioration region, it is possible to achieve high accuracy of detection of the deterioration region. Furthermore, by detecting the object region and the deterioration region by using the compressed image obtained by compressing the processing target and the divided image obtained by dividing the image to be processed, it is possible to suppress an increase in processing performance necessary for the detection.

### Third Embodiment

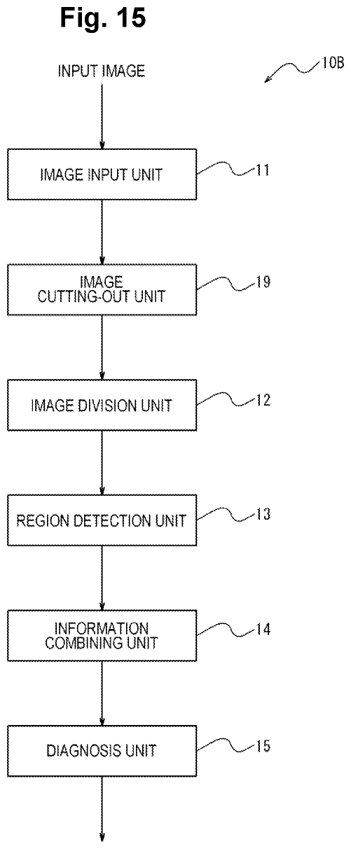

FIG. 15 is a diagram illustrating a configuration example of an image processing device 10B according to a third embodiment of the present disclosure. In FIG. 15, components similar to those of FIG. 1 are denoted by the same reference signs, and description thereof will be omitted.

As illustrated in FIG. 15, the image processing device 10B according to the present embodiment includes the image input unit 11, the image division unit 12, the region detection unit 13, the information combining unit 14, the diagnosis unit 15, and an image cutting-out unit 19. The image processing device 10B according to the present embodiment is different from the image processing device 10 according to the first embodiment in that the image cutting-out unit 19 is added.

The image cutting-out unit 19 cuts out an image of a rectangular region including a predetermined object as an image to be processed from the input image input to the image input unit 11, and outputs the image to the image division unit 12. By doing this, since the size of the image input to each of blocks after the image cutting-out unit 19 is reduced, calculation processing can be speeded up.

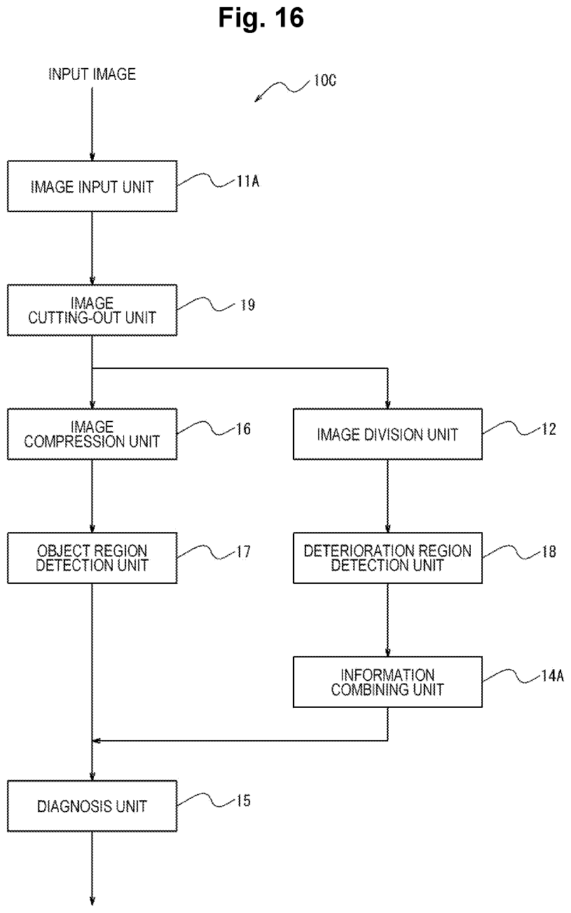

Note that, in FIG. 15, an example has been described in which the image cutting-out unit 19 is added to the image processing device 10 according to the first embodiment to configure the image processing device 10B, but the present invention is not limited thereto. As illustrated in FIG. 16, the image cutting-out unit 19 may be added to the image processing device 10A according to the second embodiment to configure an image processing device 10C. In this case, the image input unit 11 outputs the input image to the image cutting-out unit 19, and the image cutting-out unit 19 cuts out an image of a rectangular region including a predetermined object from the input image, and outputs the image to the image division unit 12 and the image compression unit 16.

Next, a description will be given of a hardware configuration of the image processing devices 10, 10A, 10B, and 10C according to the embodiments described above.

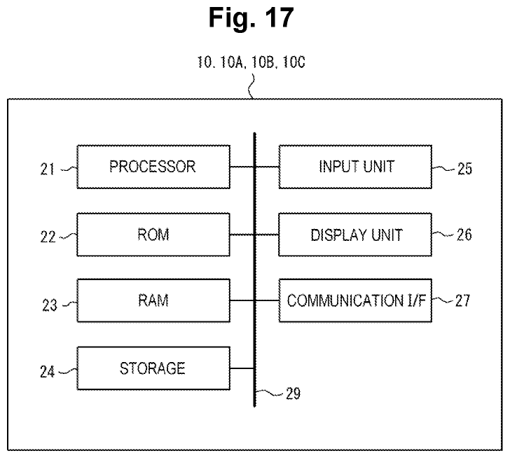

FIG. 17 is a diagram illustrating an example of a hardware configuration of the image processing devices 10, 10A, 10B, and 10C according to the embodiments described above. FIG. 17 illustrates an example of the hardware configuration of the image processing device 10 in a case where the image processing devices 10, 10A, 10B, and 10C include a computer capable of executing program instructions. Here, the computer may be a general-purpose computer, a dedicated computer, a workstation, a personal computer (PC), an electronic notepad, or the like. The program instructions may be program codes, code segments, and the like for executing a required task.

As illustrated in FIG. 17, the image processing devices 10, 10A, 10B, and 10C include a processor 21, a read only memory (ROM) 22, a random access memory (RAM) 23, a storage 24, an input unit 25, a display unit 26, and a communication interface (I/F) 27. The components are communicably connected with each other via a bus 29. Specifically, the processor 21 is a central processing unit (CPU), a micro processing unit (MPU), a graphics processing unit (GPU), a digital signal processor (DSP), a system on a chip (SoC), or the like, and may be configured by a plurality of processors of the same type or different types.

The processor 21 is a control unit that executes control of the components and various types of arithmetic processing. That is, the processor 21 reads a program from the ROM 22 or the storage 24 and executes the program using the RAM 23 as a work area. The processor 21 executes control of the components and various types of arithmetic processing in accordance with a program stored in the ROM 22 or the storage 24. In the present embodiment, the ROM 22 or the storage 24 stores a program for causing the computer to function as the image processing devices 10, 10A, 10B, and 10C according to the present disclosure. The program is read and executed by the processor 21, whereby each configuration of the image processing devices 10, 10A, 10B, and 10C described above is implemented.

The program may be provided in a form in which the program is stored in a non-transitory storage medium, such as a compact disk read only memory (CD-ROM), a digital versatile disk read only memory (DVD-ROM), or a universal serial bus (USB) memory. Furthermore, the program may be downloaded from an external device via a network.

The ROM 22 stores various programs and various types of data. The RAM 23 as a work area temporarily stores programs or data. The storage 24 includes a hard disk drive (HDD) or a solid state drive (SSD) and stores various programs including an operating system and various types of data.

The input unit 25 includes a pointing device such as a mouse and a keyboard, and is used to perform various inputs.

The display unit 26 is, for example, a liquid crystal display, and displays various types of information. The display unit 26 may function as the input unit 25 by employing a touchscreen system.

The communication interface 27 is an interface for communicating with other devices, and is, for example, an interface for a LAN. For example, an image as a target of cutting-out of the cutout image is input to the image input unit 11 via the communication interface 27. Furthermore, for example, a cutout image after the standardization is output to the outside via the communication interface 27.

A computer can be suitably used to function as each unit of the image processing devices 10, 10A, 10B, and 10C described above. Such a computer can be implemented by storing a program in which processing contents for implementing a function of each unit of the image processing devices 10, 10A, 10B, and 10C are written in a storage unit of the computer and causing a processor of the computer to read and execute the program. That is, the program can cause the computer to function as the image processing devices 10, 10A, 10B, and 10C described above. Furthermore, the program can also be recorded in a non-transitory storage medium. Furthermore, the program can also be provided via the network.

With regard to the above embodiments, the following supplementary notes are further disclosed.

### [Supplement 1]

An image processing device including:
a memory; and
a control unit connected to the memory, in which the control unit
divides an image to be processed including a predetermined object into a plurality of divided images having a predetermined size;
detects, for each of the plurality of divided images, an object region that is a pixel region of the object in each divided image and a deterioration region that is a pixel region of a deterioration portion of the object;
generates an object detection result image obtained by combining images of a plurality of the object regions detected for the respective plurality of divided images while maintaining a positional relationship among the plurality of divided images, and a deterioration detection result image obtained by combining images of a plurality of the deterioration regions detected for the respective plurality of divided images while maintaining the positional relationship among the plurality of divided images; and
diagnoses deterioration of the object on the basis of the object detection result image and the deterioration detection result image.

### [Supplement 2]

An image processing device including:
a memory; and
a control unit connected to the memory, in which
the control unit
divides an image to be processed including a predetermined object into a plurality of divided images having a predetermined size;
compresses the image to be processed to a predetermined size;
detects an object region that is a pixel region of the object in the image compressed;
detects, for each of the plurality of divided images, a deterioration region that is a pixel region of a deterioration portion of the object in each divided image;
generates a deterioration detection result image obtained by combining images of a plurality of the deterioration regions detected for the respective plurality of divided images while maintaining a positional relationship among the plurality of divided images; and
diagnoses deterioration of the object on the basis of an object detection result image that is an image of the object region in the image compressed and the deterioration detection result image.

### [Supplement 3]

The image processing device according to supplement 1, in which
the control unit determines the number of divisions in a width direction of the image to be processed such that a product of a size in the width direction of the divided image and the number of divisions in the width direction of the image to be processed is greater than or equal to a size in the width direction of the image to be processed, and determines the number of divisions in a height direction of the image to be processed such that a product of a size in the height direction of the divided image and the number of divisions in the height direction of the image to be processed is greater than or equal to a size in the height direction of the image to be processed.

### [Supplement 4]

The image processing device according to supplement 3, in which
in a case where a sum region of the divided images formed by arranging the divided images by the number of divisions determined in each of the height direction and the width direction is greater than the image to be processed, the control unit divides the image to be processed into the plurality of divided images such that the center of the sum region of the divided images coincides with the center of the image to be processed.

### [Supplement 5]

The image processing device according to supplement 4, in which
in the case where the sum region of the divided images formed by arranging the divided images by the number of divisions determined in each of the height direction and the width direction is greater than the image to be processed, the control unit superimposes adjacent divided images to match a size of the sum region of the divided images with a size of the image to be processed.

### [Supplement 6]

The image processing device according to supplement 1, in which
the control unit cuts out an image of a rectangular region including the predetermined object as the image to be processed from an input image

### [Supplement 7]

An image processing method by an image processing device, the image processing method including:
dividing an image to be processed including a predetermined object into a plurality of divided images having a predetermined size;
detecting, for each of the plurality of divided images, an object region that is a pixel region of the object in each divided image and a deterioration region that is a pixel region of a deterioration portion of the object;
generating an object detection result image obtained by combining images of a plurality of the object regions detected for the respective plurality of divided images while maintaining a positional relationship among the plurality of divided images, and a deterioration detection result image obtained by combining images of a plurality of the deterioration regions detected for the respective plurality of divided images while maintaining the positional relationship among the plurality of divided images; and
diagnosing deterioration of the object on the basis of the object detection result image and the deterioration detection result image.

### [Supplement 8]

A non-transitory storage medium storing a program executable by a computer, the non-transitory storage medium storing a program that causes the computer to operate as the image processing device according to supplement 1.

Although the above embodiments have been described as typical examples, it is obvious to those skilled in the art that many modifications and substitutions can be made within the spirit and scope of the present disclosure. Thus, it should not be understood that the present invention is limited by the embodiments described above, and various modifications or changes can be made without departing from the scope of the claims. For example, a plurality of configuration blocks described in the configuration diagram of the embodiments can be combined into one, or one configuration block can be divided.

### REFERENCE SIGNS LIST

10, 10A, 10B, 10C Image processing device
11, 11A Image input unit
12 Image division unit
13 Region detection unit
14, 14A Information combining unit
15 Diagnosis unit
16 Image compression unit
17 Object region detection unit
18 Deterioration region detection unit
19 Image cutting-out unit
121 Number-of-divisions determination unit
122 Division execution unit
131 Model construction unit
132, 172 Object detection unit
133, 182 Deterioration detection unit
1311, 171 Object detection learning unit
1312, 181 Deterioration detection learning unit
21 Processor
22 ROM
23 RAM
24 Storage
25 Input unit
26 Display unit
27 Communication I/F
29 Bus

1. An image processing device comprising:
an image division unit that divides an image to be processed including a predetermined object into a plurality of divided images having a predetermined size;
a region detection unit that detects, for each of the plurality of divided images, an object region that is a pixel region of the object in each divided image and a deterioration region that is a pixel region of a deterioration portion of the object;
an information combining unit that generates an object detection result image obtained by combining images of a plurality of the object regions detected for the respective plurality of divided images while maintaining a positional relationship among the plurality of divided images, and a deterioration detection result image obtained by combining images of a plurality of the deterioration regions detected for the respective plurality of divided images while maintaining the positional relationship among the plurality of divided images; and
a diagnosis unit that diagnoses deterioration of the object on a basis of the object detection result image and the deterioration detection result image.

2. An image processing device comprising:
an image division unit that divides an image to be processed including a predetermined object into a plurality of divided images having a predetermined size;
an image compression unit that compresses the image to be processed to a predetermined size;
an object region detection unit that detects an object region that is a pixel region of the object in the image compressed;
a deterioration region detection unit that detects, for each of the plurality of divided images, a deterioration region that is a pixel region of a deterioration portion of the object in each divided image;
an information combining unit that generates a deterioration detection result image obtained by combining images of a plurality of the deterioration regions detected for the respective plurality of divided images while maintaining a positional relationship among the plurality of divided images; and
a diagnosis unit that diagnoses deterioration of the object on a basis of an object detection result image that is an image of the object region in the image compressed and the deterioration detection result image.

3. The image processing device according to claim 1, wherein
the image division unit determines a number of divisions in a width direction of the image to be processed such that a product of a size in the width direction of the divided image and the number of divisions in the width direction of the image to be processed is greater than or equal to a size in the width direction of the image to be processed, and determines a number of divisions in a height direction of the image to be processed such that a product of a size in the height direction of the divided image and the number of divisions in the height direction of the image to be processed is greater than or equal to a size in the height direction of the image to be processed.

4. The image processing device according to claim 3, wherein
in a case where a sum region of the divided images formed by arranging the divided images by the number of divisions determined in each of the height direction and the width direction is greater than the image to be processed, the image division unit divides the image to be processed into the plurality of divided images such that a center of the sum region of the divided images coincides with a center of the image to be processed.

5. The image processing device according to claim 3, wherein
in a case where a sum region of the divided images formed by arranging the divided images by the number of divisions determined in each of the height direction and the width direction is greater than the image to be processed, the image division unit superimposes adjacent divided images to match a size of the sum region of the divided images with a size of the image to be processed.

6. The image processing device according to claim 1, further comprising
an image cutting-out unit that cuts out an image of a rectangular region including the predetermined object as the image to be processed from an input image.

7. An image processing method by an image processing device, the image processing method comprising:
dividing an image to be processed including a predetermined object into a plurality of divided images having a predetermined size;
detecting, for each of the plurality of divided images, an object region that is a pixel region of the object in each divided image and a deterioration region that is a pixel region of a deterioration portion of the object;
generating an object detection result image obtained by combining images of a plurality of the object regions detected for the respective plurality of divided images while maintaining a positional relationship among the plurality of divided images, and a deterioration detection result image obtained by combining images of a plurality of the deterioration regions detected for the respective plurality of divided images while maintaining the positional relationship among the plurality of divided images; and
diagnosing deterioration of the object on a basis of the object detection result image and the deterioration detection result image.

8. (canceled)

9. The image processing device according to claim 2, wherein
the image division unit determines a number of divisions in a width direction of the image to be processed such that a product of a size in the width direction of the divided image and the number of divisions in the width direction of the image to be processed is greater than or equal to a size in the width direction of the image to be processed, and determines a number of divisions in a height direction of the image to be processed such that a product of a size in the height direction of the divided image and the number of divisions in the height direction of the image to be processed is greater than or equal to a size in the height direction of the image to be processed.

10. The image processing device according to claim 9, wherein
in a case where a sum region of the divided images formed by arranging the divided images by the number of divisions determined in each of the height direction and the width direction is greater than the image to be processed, the image division unit divides the image to be processed into the plurality of divided images such that a center of the sum region of the divided images coincides with a center of the image to be processed.

11. The image processing device according to claim 9, wherein
in a case where a sum region of the divided images formed by arranging the divided images by the number of divisions determined in each of the height direction and the width direction is greater than the image to be processed, the image division unit superimposes adjacent divided images to match a size of the sum region of the divided images with a size of the image to be processed.

12. The image processing device according to claim 2, further comprising
an image cutting-out unit that cuts out an image of a rectangular region including the predetermined object as the image to be processed from an input image.

13. The image processing method according to claim 7, wherein
determining a number of divisions in a width direction of the image to be processed such that a product of a size in the width direction of the divided image and the number of divisions in the width direction of the image to be processed is greater than or equal to a size in the width direction of the image to be processed, and determining a number of divisions in a height direction of the image to be processed such that a product of a size in the height direction of the divided image and the number of divisions in the height direction of the image to be processed is greater than or equal to a size in the height direction of the image to be processed.

14. The image processing method according to claim 13, wherein
in a case where a sum region of the divided images formed by arranging the divided images by the number of divisions determined in each of the height direction and the width direction is greater than the image to be processed, the image division unit divides the image to be processed into the plurality of divided images such that a center of the sum region of the divided images coincides with a center of the image to be processed.

15. The image processing method according to claim 13, wherein
in a case where a sum region of the divided images formed by arranging the divided images by the number of divisions determined in each of the height direction and the width direction is greater than the image to be processed, the image division unit superimposes adjacent divided images to match a size of the sum region of the divided images with a size of the image to be processed.

16. The image processing method according to claim 7, further comprising:
cutting out an image of a rectangular region including the predetermined object as the image to be processed from an input image.

17. The image processing device according to claim 2, wherein
the degraded are detection unit receives a plurality of divided images obtained by dividing the image to be processed by an image dividing unit.

18. The image processing device according to claim 2, wherein
a deteriorated area detection unit detects a deteriorated area, which is a pixel area of the deteriorated portion of the object in each of the divided images, for each of the divided images.

19. The image processing device according to claim 2, wherein
the degraded are detection unit creates a model for detecting a degraded area from a divided image and detects a degraded area from the divided image using a created mode.

20. The image processing device according to claim 18, wherein
a deterioration detection learning unit uses the divided image and a mask image indicating a deteriorated area in the divided image to create a deterioration detector that detects a deteriorated area in the image.

21. The image processing device according to claim 19, wherein
the deteriorated area detection unit uses a degraded area in an input image as an input to the deterioration detection learning unit and the deterioration detector outputs detection result.
